(19) United States
(12) Patent Application Publication
(10) Pub. No.: US 2013/0222098 A1
(43) Pub. Date: Aug. 29, 2013

(54) Permanent Magnet Apparatus Usable for Storing Energy

(71) Applicant: Wayne M. Monson, Winnipeg (CA)

(72) Inventor: Wayne M. Monson, Winnipeg (CA)

(21) Appl. No.: 13/862,921

(22) Filed: Apr. 15, 2013

Related U.S. Application Data
(63) Continuation-in-part of application No. 12/641,857, filed on Dec. 18, 2009, now abandoned.
(60) Provisional application No. 61/165,564, filed on Apr. 1, 2009.

(51) Int. Cl. H01F 7/02

(52) U.S. Cl. CPC H01F 7/0231
USPC 335/306

(57) ABSTRACT

A permanent magnet apparatus has a first ferromagnetic member and a second ferromagnetic member movable in working direction relative to the first ferromagnetic member. A controller displaces a permanent magnet between an engaged position adjacent to the ferromagnetic members with the flux being perpendicular to the working direction and a disengaged position spaced from the first and second ferromagnetic members. The second ferromagnetic member is biased from the first position to the second position relative to the first ferromagnetic member when the driving magnet is in the engaged position so as to be arranged to selectively drive an output movement in response to an input to the controller which displaces the ferromagnetic members and the driving magnet relative to one another to store potential energy by placement of the driving magnet in the engaged position subsequent to locating the ferromagnetic members in the first position.

This application is a continuation-in-part of U.S. application Ser. No. 12/641,857, filed Dec. 18, 2009 and claims the benefit under 35 U.S.C. 119(e) of U.S. provisional application Ser. No. 61/139,732, filed Dec. 22, 2008; U.S. provisional application Ser. No. 61/145,809, filed Jan. 20, 2009; and U.S. provisional application Ser. No. 61/165,564, filed Apr. 1, 2009.

### FIELD OF THE INVENTION

The present invention relates to a permanent magnet apparatus and a related method of use of the permanent magnet apparatus for storing energy for subsequent use, and more particularly the present invention relates to a permanent magnet apparatus using permanent magnets to selectively linearly displace an output member in response to linear displacement of an input member of the apparatus.

### BACKGROUND

U.S. Pat. No. 3,879,622 by Ecklin discloses one example of a permanent magnet apparatus which uses the energy stored in the fields of permanent magnets to produce work in order to satisfy subsequent energy needs. The permanent magnet apparatus in one embodiment utilizes a spring-biased reciprocating magnetizable member positioned between two permanent magnets. Magnetic shields in the form of rotatable shutters are located between each permanent magnet and the reciprocating member to alternately shield and expose the member to the magnetic field thereby producing reciprocating motion. As the shutters can only shield a very small magnetic field, the power extracted from the reciprocating member is very small.

U.S. Pat. No. 5,432,382 discloses another example of permanent magnets being used for storing energy for subsequent use. A movable magnet reciprocates between to longitudinally opposed magnets which limit the overall stroke length permitted.

### SUMMARY OF THE INVENTION

According to one aspect of the present invention there is provided a magnet apparatus comprising:

a first ferromagnetic member;

a second ferromagnetic member supported for movement in a working direction relative to the first ferromagnetic member between a first position adjacent the first ferromagnetic member and a second position spaced apart from the first ferromagnetic member;

a driving magnet comprising a permanent magnet having a magnetic flux oriented in a flux direction from a first pole at a first end face of the magnet to a second pole at a second end face of the magnet;

the driving magnet being movable relative to the first ferromagnetic member between an engaged position in which the driving magnet is supported in proximity to the first and second ferromagnetic members and the flux direction is oriented substantially perpendicularly to the working direction of the second ferromagnetic member and a disengaged position in which the driving magnet is positioned farther from the first and second ferromagnetic members than in the engaged position; and

a controller operatively associated with the ferromagnetic members and the driving magnet so as to be arranged in response to an input to drive a sequence of movements including:
i) displacement of the driving magnet relative to the second ferromagnetic member in the second position from the engaged position to the disengaged position;
ii) displacement of the second ferromagnetic member relative to the first ferromagnetic member from the second position to the first position in the disengaged position of the driving magnet;
iii) displacement of the driving magnet relative to the second ferromagnetic member in the first position from the disengaged position to the engaged position;

whereby the second ferromagnetic member is biased from the first position to the second position relative to the first ferromagnetic member when the driving magnet is in the engaged position relative to the ferromagnetic members so as to be arranged to selectively drive an output movement in response to the input to the controller.

Preferably the controller further comprises a latching mechanism arranged to latch the second ferromagnetic member in the first position relative to the first ferromagnetic member when the driving magnet is in the disengaged position relative to the ferromagnetic members, the latching mechanism being selectively releasable so as drive the output movement when the latching mechanism is released on demand.

In one preferred embodiment the driving magnet comprises a first movable magnet and there is provided an additional driving magnet comprising a second movable magnet. Also in the preferred embodiment, the second movable magnet comprises a permanent magnet having a magnetic flux oriented in a flux direction from a first pole at a first end face of the magnet to a second pole at a second end face of the magnet; the second movable magnet being movable relative to the first ferromagnetic member between an engaged position in which the second movable magnet is supported in proximity to the first and second ferromagnetic members and the flux direction is oriented substantially perpendicularly to the working direction of the second ferromagnetic member in alignment with the flux direction of the first movable magnet and a disengaged position in which the driving magnet is positioned farther from the first and second ferromagnetic members than in the engaged position thereof; and the controller being arranged to reciprocate both the first and second movable magnets between the engaged position and the disengaged position thereof.

The first and second movable magnets may be movable together between the engaged and disengaged positions thereof.

The first and second movable magnets may be movable between the engaged and disengaged positions thereof in a common direction oriented perpendicularly to the flux directions thereof.

The first and second movable magnets may be supported spaced apart from one another in the flux direction in the engaged position of the magnets on opposing sides of the ferromagnetic members received therebetween.

The first and second ferromagnetic members may comprise flat plate members lying parallel to one another in respective planes oriented parallel to the flux directions of the movable magnets in which each of the plate members spans between opposing side edges in proximity to the first and second permanent magnets in the engaged position respectively.

The first and second ferromagnetic members may comprise flat plate members lying parallel to one another and being substantially perpendicular to the working direction.

The first and second ferromagnetic members may comprise flat plate members which are elongate in a direction of movement of the driving magnet.

There may be provided a first fixed magnet comprising a permanent magnet supported in fixed relation to the first ferromagnetic member and having a magnetic flux oriented parallel and in alignment with the flux direction of the driving magnet in the engaged position.

The first fixed magnet and the driving magnet may be spaced apart in the flux direction on opposing sides of first ferromagnetic member.

The first and second ferromagnetic members may span one of the end faces of the driving magnet in the engaged position.

There may be provided a first fixed magnet and a second fixed magnet in which each fixed magnet comprises a permanent magnet supported in fixed relation to the first ferromagnetic member and having a magnetic flux oriented parallel and in alignment with the flux direction of the driving magnet in the engaged position, the first and second fixed magnets being supported spaced apart in the flux direction on opposing sides of the first ferromagnetic member.

The second fixed magnet may be received between first ferromagnetic member and the driving magnet in the engaged position of the driving magnet.

The working direction may be parallel to the end face of driving magnet which is nearest to the first ferromagnetic member.

The driving magnet may be movable between the engaged and disengaged positions thereof in a plane which substantially parallel to working direction.

The driving magnet may be movable between the engaged and disengaged positions thereof perpendicularly to the flux direction and perpendicularly to the working direction of the first and second ferromagnetic members.

The controller may be arranged to linearly reciprocate the driving magnet between the engaged position and the disengaged position thereof.

The first and second ferromagnetic members may be curved about a central axis in which the working direction is oriented radially in relation to the central axis and the driving magnet is movable in a tangential direction in relation to the central axis. The controller may be arranged to cyclically rotate the driving magnet between the engaged position and the disengaged position thereof.

According to a second aspect of the present invention there is provided a magnet apparatus comprising:

a ferromagnetic member supported for movement in a working direction a first position and a second position spaced apart from the first position;

a driving magnet comprising a permanent magnet having a magnetic flux oriented in a flux direction from a first pole at a first end face of the magnet to a second pole at a second end face of the magnet;

the driving magnet being movable relative to the ferromagnetic member between an engaged position in which the driving magnet is supported in proximity to the ferromagnetic member and the flux direction is oriented substantially perpendicularly to the working direction of the ferromagnetic member and a disengaged position in which the driving magnet is positioned farther from the ferromagnetic member than in the engaged position; and

a controller operatively associated with the ferromagnetic member and the driving magnet so as to be arranged in response to an input to drive a sequence of movements including:
i) displacement of the driving magnet relative to the ferromagnetic member in the second position from the engaged position to the disengaged position;
ii) displacement of the ferromagnetic member relative to the driving magnet from the second position to the first position in the disengaged position of the driving magnet;
iii) displacement of the driving magnet relative to the ferromagnetic member in the first position from the disengaged position to the engaged position;

whereby the ferromagnetic member is biased by the driving magnet from the first position to the second position when the driving magnet is in the engaged position relative to the ferromagnetic member so as to be arranged to selectively drive an output movement in response to the input to the controller.

According to another aspect of the invention there is provided a magnet apparatus comprising:

first and second permanent magnets, each having a magnetic flux oriented in a flux direction from a first pole at a first end of the magnet to a second pole at a second end of the magnet respectively;

the first and second permanent magnets being oriented such that the respective flux directions are commonly directed in a longitudinal direction;

the first and second permanent magnets being supported spaced apart from one another in said longitudinal direction;

a ferromagnetic member supported between the first and second magnets so as to be arranged for movement in a first working direction oriented perpendicularly to the longitudinal direction between a first position in which the ferromagnetic member is substantially centered relative to first and second permanent magnets in the working direction and a second position in which the ferromagnetic member is offset from the first position in the working direction such that the ferromagnetic member is biased by the first and second permanent magnets from the second position towards the first position;

at least one auxiliary permanent magnet having a magnetic flux oriented in a flux direction from a first pole at a first end of the magnet to a second pole at a second end of the magnet;

said at least one auxiliary permanent magnet being supported for movement in a second working direction transverse to the longitudinal direction of the first and second permanent magnets between a first position adjacent one end of the first permanent magnet opposite from the second permanent magnet in which the flux direction is directed in the longitudinal direction and a second position offset from the first position in the lateral direction; and

a controller arranged to displace said at least one auxiliary permanent magnet between the first position and the second position thereof;

the controller being further arranged to displace the ferromagnetic member from the first position to the second position when said at least one auxiliary permanent magnet is in the second position; and

the controller being arranged to store and selectively release the energy from the magnetic biasing which biases the ferromagnetic member from the second position to the first position when said at least one auxiliary magnet is in the first position.

According to a further aspect of the present invention there is provided a method of storing energy for subsequent use comprising:

providing first and second permanent magnets, each having a magnetic flux oriented in a flux direction from a first pole at a first end of the magnet to a second pole at a second end of the magnet respectively;

orienting the first and second permanent magnets such that the respective flux directions are commonly directed in a longitudinal direction;

supporting the first and second permanent magnets spaced apart from one another in said longitudinal direction;

supporting a ferromagnetic member between the first and second magnets so as to be arranged for movement in a working direction oriented perpendicularly to the longitudinal direction between a first position in which the ferromagnetic member is substantially centered relative to first and second permanent magnets in the working direction and a second position in which the ferromagnetic member is offset from the first position in the working direction such that the ferromagnetic member is biased by the first and second permanent magnets from the second position towards the first position;

providing at least one auxiliary permanent magnet having a magnetic flux oriented in a flux direction from a first pole at a first end of the magnet to a second pole at a second end of the magnet;

supporting said at least one auxiliary permanent magnet for movement in a lateral direction transverse to the longitudinal direction of the first and second permanent magnets between a first position adjacent one end of the first permanent magnet opposite from the second permanent magnet in which the flux direction is directed in the longitudinal direction and a second position offset from the first position in the lateral direction;

driving said at least one auxiliary permanent magnet from the first position to the second position thereof;

displacing the ferromagnetic member from the first position to the second position when said at least one auxiliary permanent magnet is in the second position; and

returning said at least one auxiliary permanent magnet from the second position to the first position thereof when the ferromagnetic member is in the second position so as to store potential energy in the ferromagnetic member as the ferromagnetic member is biased from the second position to the first position under magnetic force of said at least one auxiliary magnet in the first position.

Some embodiments of the invention will now be described in conjunction with the accompanying drawings in which:

### BRIEF DESCRIPTION OF THE DRAWINGS

FIGS. 1A, 1B and 1C illustrate top, side and end views of the apparatus in a first portion of the cycle according to a first embodiment.

FIGS. 2A, 2B and 2C illustrate top, side and end views of the apparatus in a second portion of the cycle according to the first embodiment.

FIGS. 3A, 3B and 3C illustrate top, side and end views of the apparatus in a third portion of the cycle according to the first embodiment.

FIGS. 4A, 4B and 4C illustrate illustrates top, side and end views of the apparatus in a fourth portion of the cycle according to the first embodiment.

FIGS. 5A, 5B and 5C illustrate illustrates top, side and end views of the apparatus in a first portion of the cycle according to a second embodiment.

FIGS. 6A, 6B and 6C illustrate illustrates top, side and end views of the apparatus in a second portion of the cycle according to the second embodiment.

FIGS. 7A, 7B and 7C illustrate illustrates top, side and end views of the apparatus in a third portion of the cycle according to the second embodiment.

FIGS. 8A, 8B and 8C illustrate illustrates top, side and end views of the apparatus in a fourth portion of the cycle according to the second embodiment.

FIGS. 9A, 9B and 9C illustrate top, side and end views of the apparatus in a first portion of the cycle according to a third embodiment.

FIGS. 10A, 10B and 10C illustrate top, side and end views of the apparatus in a second portion of the cycle according to the third embodiment.

FIGS. 11A, 11B and 11C illustrate top, side and end views of the apparatus in a third portion of the cycle according to the third embodiment.

FIGS. 12A, 12B and 12C illustrate top, side and end views of the apparatus in a fourth portion of the cycle according to the third embodiment.

FIGS. 13A, 13B and 13C illustrate top, side and end views of the apparatus in a first portion of the cycle according to a fourth embodiment.

FIGS. 14A, 14B and 14C illustrate top, side and end views of the apparatus in a second portion of the cycle according to the fourth embodiment.

FIGS. 15A, 15B and 15C illustrate top, side and end views of the apparatus in a third portion of the cycle according to the fourth embodiment.

FIGS. 16A, 16B and 16C illustrate top, side and end views of the apparatus in a fourth portion of the cycle according to the fourth embodiment.

FIGS. 17A, 17B and 17C illustrate top, side and end views of the apparatus in a first portion of the cycle according to a fifth embodiment.

FIGS. 18A, 18B and 18C illustrate illustrates top, side and end views of the apparatus in a second portion of the cycle according to the fifth embodiment.

FIGS. 19A, 19B and 19C illustrate top, side and end views of the apparatus in a third portion of the cycle according to the fifth embodiment.

FIGS. 20A, 20B and 20C illustrate top, side and end views of the apparatus in a fourth portion of the cycle according to the fifth embodiment.

FIGS. 21A, 21B and 21C illustrate top, side and end views of the apparatus in a fourth portion of the cycle according to the sixth embodiment.

FIGS. 22A, 22B and 22C illustrate top, side and end views of the apparatus in a fourth portion of the cycle according to the seventh embodiment.

FIGS. 23A and 23B illustrate side and end views of the apparatus in a first portion of the cycle according to a preferred embodiment.

FIGS. 24A and 24B illustrate side and end views of the apparatus in a second portion of the cycle according to the preferred embodiment.

FIGS. 25A and 25B illustrate side and end views of the apparatus in a third portion of the cycle according to the preferred embodiment.

FIGS. 26A and 26B illustrate side and end views of the apparatus in a fourth portion of the cycle according to the preferred embodiment.

FIGS. 27 and 28 are graphical representations of the forces involved for the movements of the elements of the apparatus between the first and fourth portions of the cycle according to exemplary embodiments.

In the drawings like characters of reference indicate corresponding parts in the different figures.

### DETAILED DESCRIPTION

Referring to the accompanying figures there is illustrated a permanent magnet apparatus generally indicated by reference numeral 10. The apparatus 10 uses the magnetic flux of permanent magnets acting on ferromagnetic material to drive a linear output movement in response to a controller input.

Although various embodiments of the apparatus are described and illustrated herein, the common features of the first two embodiments will first be described.

The apparatus 10 includes a first permanent magnet 12 and a second permanent magnet 14 which are fixed relative to one another. The magnets have the same dimensions and flux density as one another so that the magnitudes of the magnetic fluxes of the magnets are identical to one another also. Each magnet extends in a longitudinal direction from a first end 16 to a second end 18. The flux is oriented in a flux direction extending between a first pole at the first end 16 and a second pole at the second end 18.

Each of the first and second permanent magnets also comprises four boundary walls 20 extending in the longitudinal direction between the first and second ends parallel to the flux direction. The boundary walls form a generally rectangular perimeter about the body of the magnet which extends in the longitudinal or flux direction. The body of the magnet is elongate in a lateral direction oriented perpendicularly to the longitudinal direction. The boundary walls thus include two opposed long sides extending in the lateral direction and two opposed short sides extending between the long sides.

The first and second permanent magnets are positioned fixed relative to one another so that the longitudinal directions thereof are aligned and more particularly so that the flux directions of the two magnets extend commonly in the longitudinal direction in alignment with one another but spaced apart from one another in the longitudinal direction such that the permanent magnets are substantially centered with one another along the longitudinal axis. The space between the first and second permanent magnets is approximately equal to the length of each one of the magnets in the longitudinal direction between the opposed first and second ends thereof.

The apparatus also includes a ferromagnetic base element 22 which is generally in the form of a flat plate formed of rolled steel sheet metal which is oriented to be parallel to the longitudinal flux direction of the first and second permanent magnets as well as being parallel to the elongate lateral direction of the magnets. The base element thus spans in width in the longitudinal direction a dimension corresponding approximately to the space between the first and second permanent magnets as well as spanning in length the lateral direction a length of the permanent magnets between the two short sides thereof. The ferromagnetic base element 22 is slightly shorter in the longitudinal direction than the space between the permanent magnets so as to be in close proximity to the two permanent magnets along the opposing edges thereof while remaining spaced therefrom so as not to be in contact with the permanent magnets. The base element 22 is positioned close to a long one of the boundary walls of the first and second permanent magnets so to be substantially flush along an outer side thereof.

The apparatus 10 also comprises a ferromagnetic member 24 which is supported for linear sliding movement relative to the first and second permanent magnets and relative to the ferromagnetic base element 22. The ferromagnetic member 24 comprises a flat plate formed of similar rolled steel sheet metal as the base element 22. The ferromagnetic member 24 is also similarly oriented to span similar dimensions of width and length and to lie parallel to both the longitudinal direction and the elongate lateral of the magnets, so as also to be parallel to the base element 22.

The ferromagnetic member 24 is moveable in a first working direction which is perpendicular to the flat plane of the member 24 as well as being perpendicular to the longitudinal direction and lateral direction of the apparatus. The member 24 is moveable between a first position which is centered relative to the boundary walls of the first and second permanent magnets and a second position adjacent one of the long sides of the boundary walls of the magnets.

More particularly in the first position the ferromagnetic member 24 is centered relative to the magnetic flux of the first and second permanent magnets so as to be balanced centrally between the first and second magnets by the magnetic attraction of the ferromagnetic member to the two magnets.

In the second position the ferromagnetic member 24 is offset and spaced in the first working direction from the location of the member 24 in the first position to be positioned adjacent the boundary wall locating the base element 22 adjacent thereto. Accordingly in the second position the ferromagnetic member 24 is biased towards the first position thereof by the magnetic force from the first and second permanent magnets as well as being repelled from the induced magnetized forces within the ferromagnetic base element 22 by the action of the first and second permanent magnets.

The movement of the ferromagnetic member 24 from the second position to the first position comprises the output of the magnet apparatus 10. The energy of this movement can be selectively stored as potential energy by selectively retaining the member 24 in the second position.

Alternatively there may be provided an electric generator which is driven by the movement of the ferromagnetic member from the second position to the first position with the electricity generated thereby being stored in an electric battery for subsequent use as may be desired.

The apparatus 10 further comprises at least one auxiliary permanent magnet 26 which is similarly configured as the first and second permanent magnets so as to have a magnetic flux which extends in a flux direction from a first pole at a first end 28 to a second pole at a second end 30. The auxiliary permanent magnet 26 further comprises boundary walls 32 in a rectangular configuration to comprise two opposed long sides and two opposed short sides which extend parallel to the flux direction between the opposed ends of the magnet. The two long sides are much longer than the two short sides so that the auxiliary permanent magnet is similarly elongate in the lateral direction perpendicular to the longitudinal direction which all of the flux directions are aligned with. The dimensions of the auxiliary permanent magnet are substantially identical as the first and second magnets.

The auxiliary permanent magnet 26 is supported for linear sliding movement in a second working direction parallel to the lateral direction of the apparatus so as to be perpendicular to both the longitudinal direction of the apparatus and the first working direction of the movement of the ferromagnetic member 24. The auxiliary permanent magnet 26 is moveable between a first position in which the magnetic flux thereof is aligned in the flux direction with the magnetic flux of the first and second permanent magnets and a second position in which the auxiliary permanent magnet is offset and spaced in the second working direction from the location of the auxiliary permanent magnet in the first position.

More particularly in the first position of the auxiliary permanent magnet 26, the magnet is abutted in end to end relationship with the first permanent magnet so that the second pole of the auxiliary permanent magnet is directly abutted with the first pole of the first permanent magnet and the flux direction is commonly oriented in the longitudinal direction. In this position the auxiliary permanent magnet serves to increase the magnitude of the flux of the first magnet which is apparent at the ferromagnetic member. The flux density is most affected when the auxiliary permanent magnet is positioned so that the boundary walls thereof are flush with the boundary walls of the first permanent magnet and the auxiliary permanent magnet is accordingly centered relative to the boundary walls of the first permanent magnet.

In the second position of the auxiliary permanent magnet the auxiliary permanent magnet is displaced in the second working direction or elongate lateral direction such that the magnet is fully offset from the first permanent magnet so that there is no overlap therebetween in the lateral direction. The magnetic flux of the first permanent magnet as felt by the moveable ferromagnetic member 24 is thus reduced as compared to the first position of the auxiliary permanent magnet.

The controller of the apparatus serves to receive an input energy or motion to drive the auxiliary permanent magnet between the first and second positions thereof in use. More particularly the controller displaces the auxiliary permanent magnet from the second position from the first position thereof once the ferromagnetic 24 reaches the first position thereof. The controller can also displace the auxiliary permanent magnet 26 to the first position thereof once the moveable ferromagnetic member 24 is in the second position thereof. The controller also serves to displace the ferromagnetic member 24 from the first position to the second position thereof once the auxiliary permanent magnet 26 is in the second position.

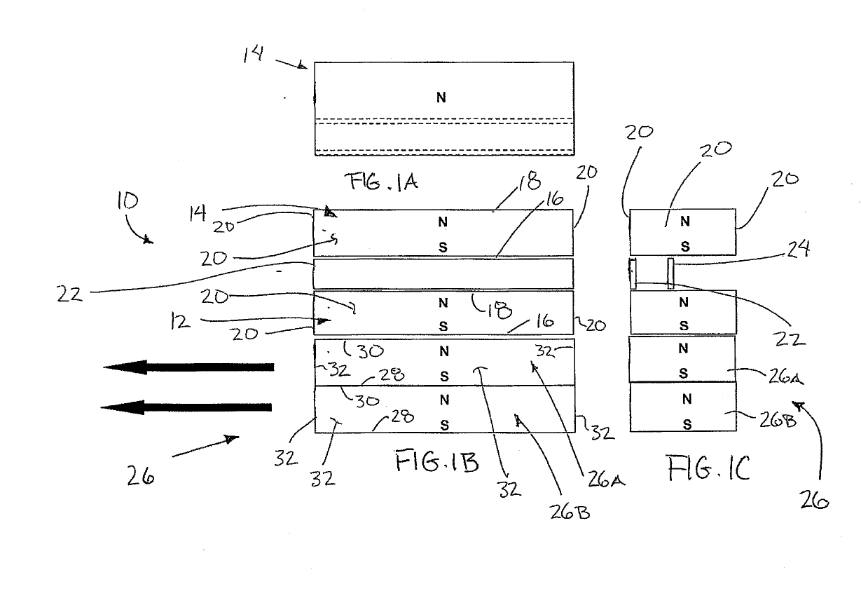

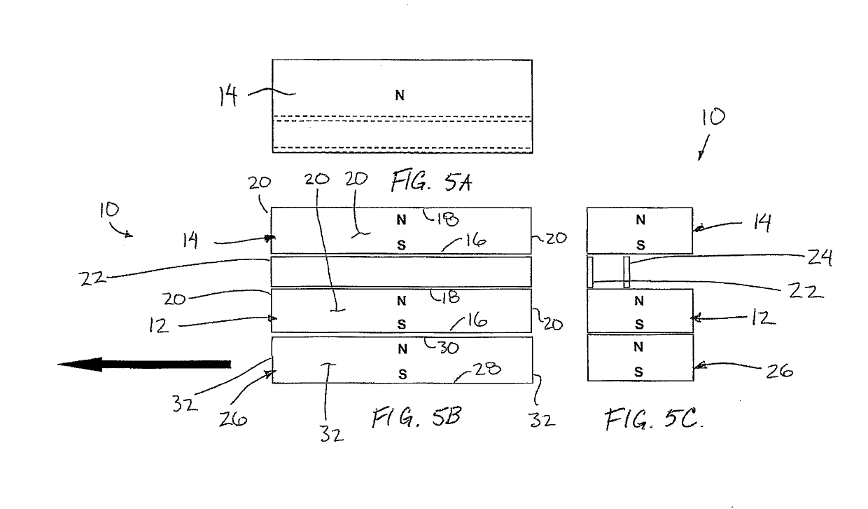

In use the apparatus 10 can be initially positioned in a first operating position as shown in FIGS. 1 and 5 in which both the auxiliary permanent magnet and the ferromagnetic member are in the respective first positions thereof. In the first cycle of operation, the auxiliary permanent magnet is displaced into the second position thereof.

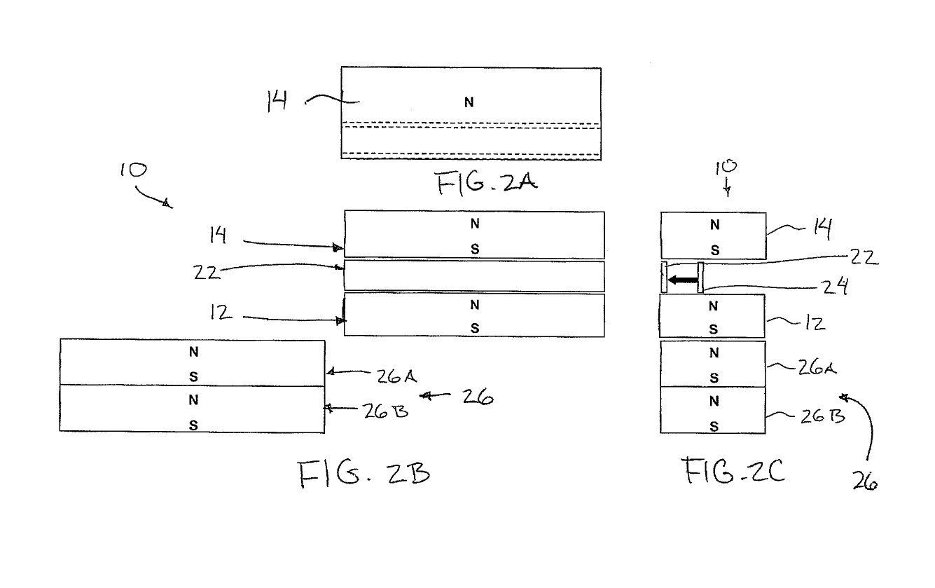

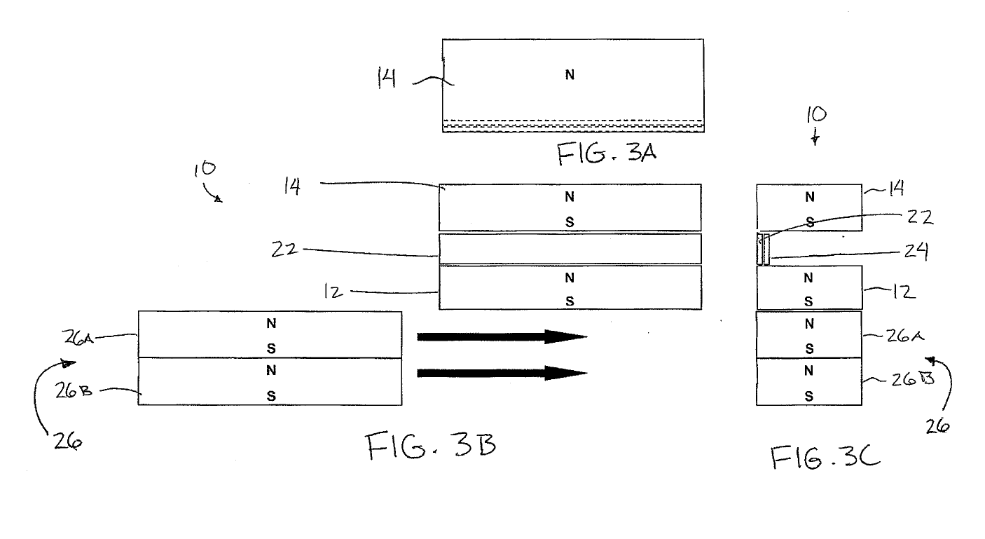

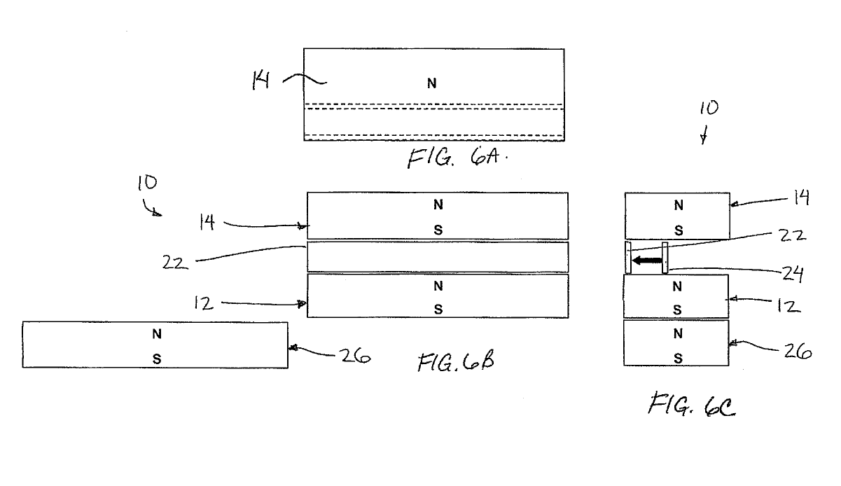

Upon completion of the first cycle, the apparatus reaches the second operating position as shown in FIGS. 2 and 6. Once the auxiliary permanent magnet reaches the second position thereof, the second cycle of the apparatus involves the ferromagnetic member being displaced from the first position into the second position thereof while the auxiliary permanent member remains in the second position thereof.

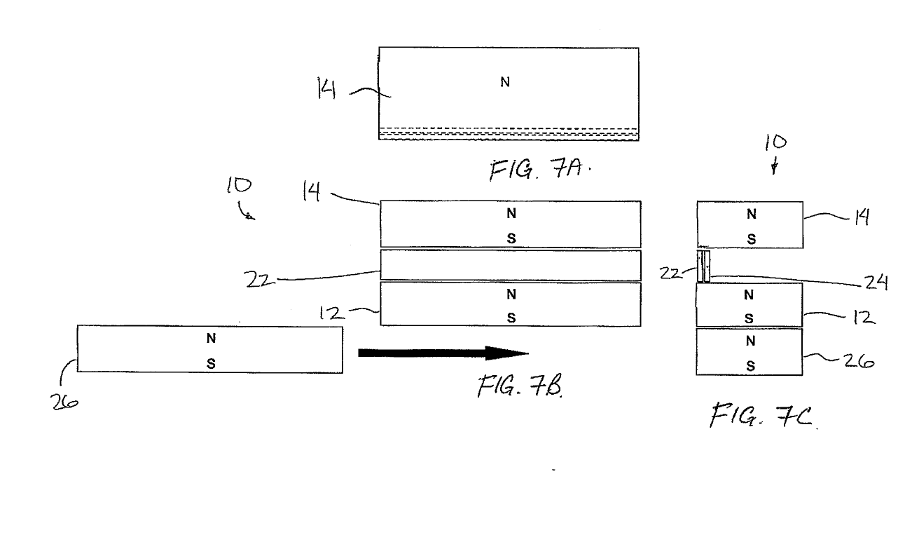

The apparatus thus reaches the third operating position as shown in FIGS. 3 and 7. The third cycle begins when the third operating position is reached and involves displacement of the auxiliary permanent magnet returning from the second position to the first position.

The first three cycles can be driven by suitable coupling to driving components of the controller.

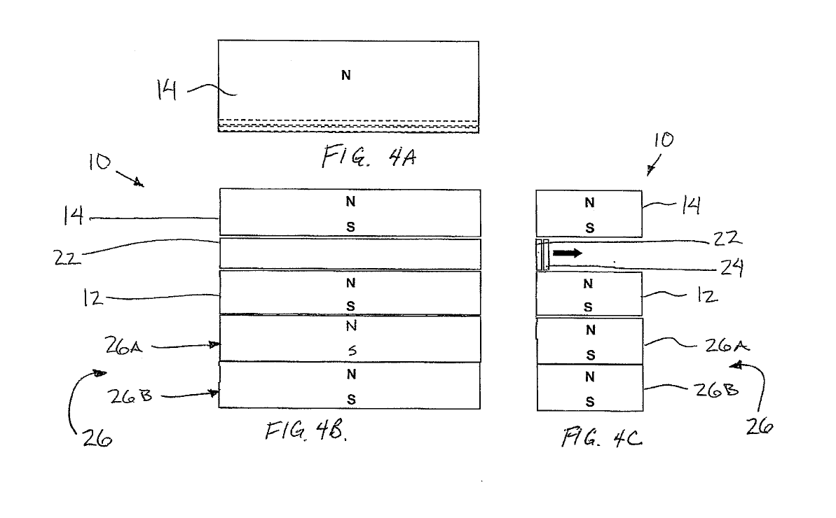

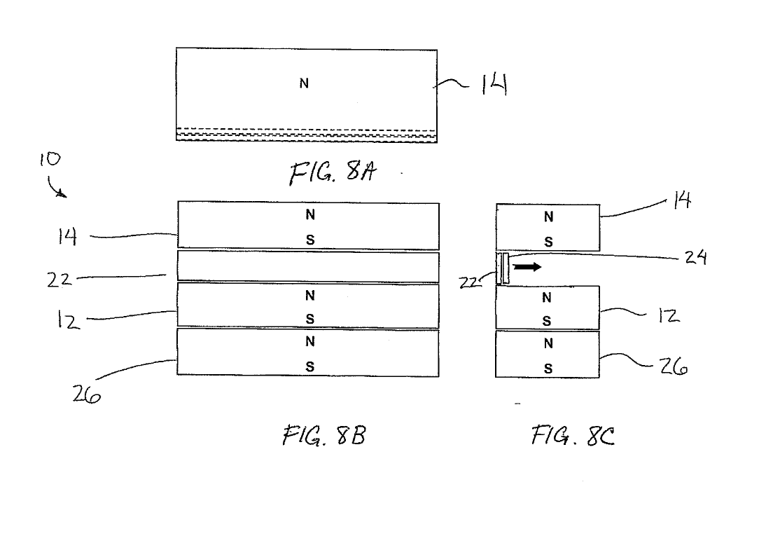

Upon the auxiliary permanent magnet returning to the first position the apparatus reaches the fourth operating position shown in FIGS. 4 through 8. The fourth cycle of the apparatus then involves the ferromagnetic member being permitted to return from the second position to the first position under action of the permanent magnets biasing the ferromagnetic member back to the first position. When in the position of FIGS. 4 and 8, potential energy is stored in the ferromagnetic member which can be controllably released by the controller on demand to drive an output movement.

Turning now more particularly to the embodiments of FIGS. 1 through 4, the at least one auxiliary permanent magnet 26 comprises a first auxiliary magnet 26A and a second auxiliary magnet 26B. The two auxiliary magnets 26A and 26B are abutted with one another in an end to end configuration so that the magnet flux is in a common flux direction in the longitudinal direction in first position thereof. The two magnets are moveable together between the first and second positions thereof. The first auxiliary magnet 26A which is closest to the first permanent magnet for direct abutment therewith in the first position has a magnitude of magnetic flux which is substantially equal to the magnitude of the magnetic flux of either one of the first or second permanent magnets. The other permanent magnet 26B farthest from the first permanent magnet has a magnitude of magnetic flux which is greater than either one of the first and second permanent magnets so that the two auxiliary magnets 26A and 26B combined have an overall magnetic flux with a magnitude which is greater than the combined magnetic flux of the first and second permanent magnets.

Turning now more particularly to the embodiment of FIGS. 5 through 8, there is provided only a single auxiliary permanent magnet 26 for movement between the first and second positions. In this instance the flux magnitude of the magnet 26 by itself is typically greater than the flux magnitude of either one of the first or second permanent magnets.

As described above, according to the first embodiment the permanent magnet field energy conversion device converts the potential energy from the magnetic field around the permanent magnets into mechanical energy upon selectively releasing the ferromagnetic member to return from the second position to the first position. The apparatus in this instance is composed generally of two assemblies, the plate carrier, the flux driver and a moveable output plate.

### Plate Carrier Assembly

The plate carrier assembly is composed of 2 ceramic permanent magnets and are separated from each other at a fixed distance with the pole faces parallel and attracting each other. Located between the plate carrier magnets is a stationary ferromagnetic plate. This fixed plate is oriented perpendicular between the carrier magnets, is flush to the outside edge of the carrier magnets, with the thinnest edges of the plate perpendicular to the pole faces of the carrier magnets, does not touch either of the carrier magnets and conducts magnetic flux from one carrier magnet to the other.

### Output Plate

Also located between the plate carrier magnets is the output plate. The output plate is oriented adjacent and parallel to the fixed plate and conducts flux between the two carrier magnets. The output plate is allowed to move away from the fixed plate further into the magnetic flux between the carrier magnets pole faces, and is not allowed to contact either of the carrier magnet pole faces while it moves.

### Flux Driver Assembly

The flux driver assembly is made up of two permanent magnets, 26A and 26B. These two permanent magnets are placed together with poles attracting and will be held to each other by their attractive force. The flux density of magnet 26A is larger than the flux density in magnet 26B. The flux density of magnets 20 is the same or less than the flux density of 26A. The flux driver permanent magnets are located next to a carrier permanent magnet with the pole face of 26A parallel and attracted by 20. The flux driver assembly is allowed to move in a plane parallel to and not touching the pole face of item 13.

### Device Operation

Cycle 1—In cycle 1 (FIG. 1) the flux driver assembly are removed from the attractive forces generated by 20.

Cycle 2—In cycle 2 (FIG. 2) the output plate is forced back adjacent to the fixed plate item 22.

Cycle 3—In cycle 3 (FIG. 3) the flux driver assembly magnets 26A and 26B is attracted by the pole face of magnet 20.

Cycle 4—In cycle 4 (FIG. 4) the output plate and fixed plate repulse each other, thus creating work from stored potential energy.

Turning now to the second embodiment of FIGS. 5 to 8, the device is again generally comprised of two assemblies, the plate carrier, the flux driver and a moveable output plate.

### Plate Carrier Assembly

The plate carrier assembly is composed of 2 ceramic permanent magnets 20 and are separated from each other at a fixed distance with the pole faces parallel and attracting each other. Located between the plate carrier magnets is a stationary ferromagnetic plate. This fixed plate is oriented perpendicular between the carrier magnets, is flush to the outside edge of the carrier magnets, with the thinnest edges of the plate perpendicular to the pole faces of the carrier magnets, does not touch either of the carrier magnets and conducts magnetic flux from one carrier magnet to the other.

### Output Plate

Also located between the plate carrier magnets is the output plate. The output plate is oriented adjacent and parallel to the fixed plate and conducts flux between the two carrier magnets. The output plate is allowed to move away from the fixed plate further into the magnetic flux between the carrier magnets pole faces, and is not allowed to contact either of the carrier magnet pole faces while it moves.

### Flux Driver Assembly

The flux driver assembly is made up of magnets 26. These magnets are placed together with poles attracting and will be held to each other by their attractive force. The flux driver permanent magnet is located next to a carrier permanent magnet with the pole face of item 26 parallel and attracted by item 12. The flux driver is allowed to move in a plane parallel to and not touching the pole face of item 12.

### Device Operation

Cycle 1—In cycle 1 (FIG. 5) the flux driver (item 26) is removed from the attractive forces generated by item 12.

Cycle 2—In cycle 2 (FIG. 6) the output plate is forced back adjacent to the fixed plate item 22.

Cycle 3—In cycle 3 (FIG. 7) the flux driver is attracted by the pole face of item 12.

Cycle 4—In cycle 4 (FIG. 8) the output plate and fixed plate repulse each other, thus creating work from stored potential energy.

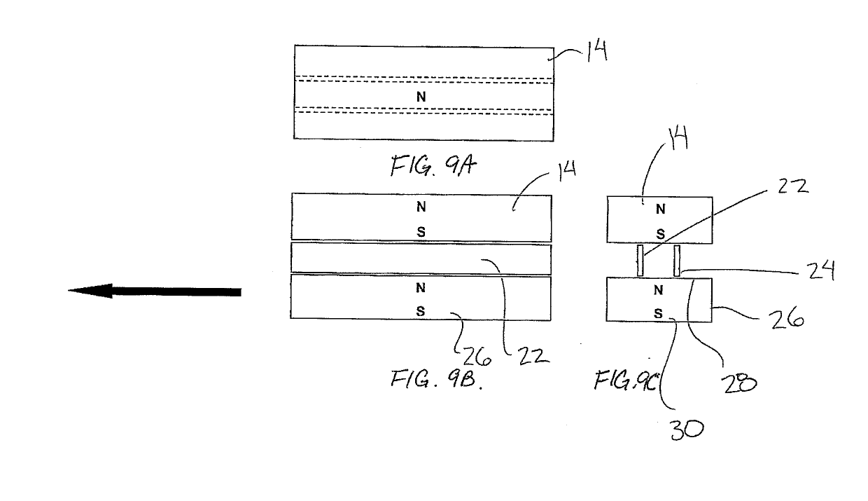

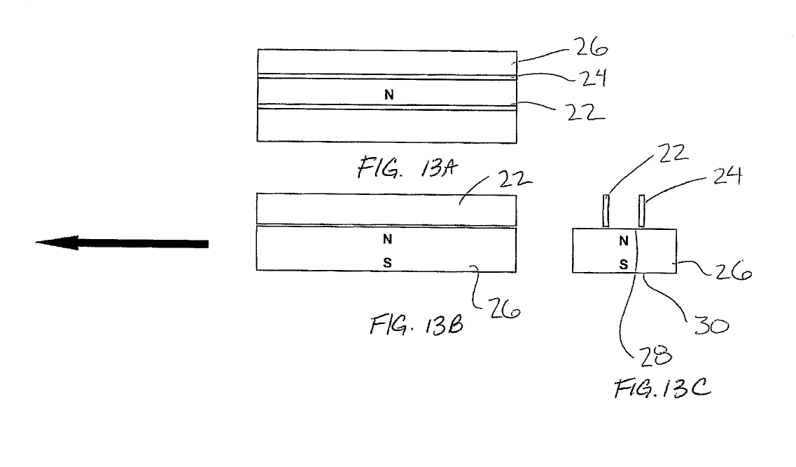

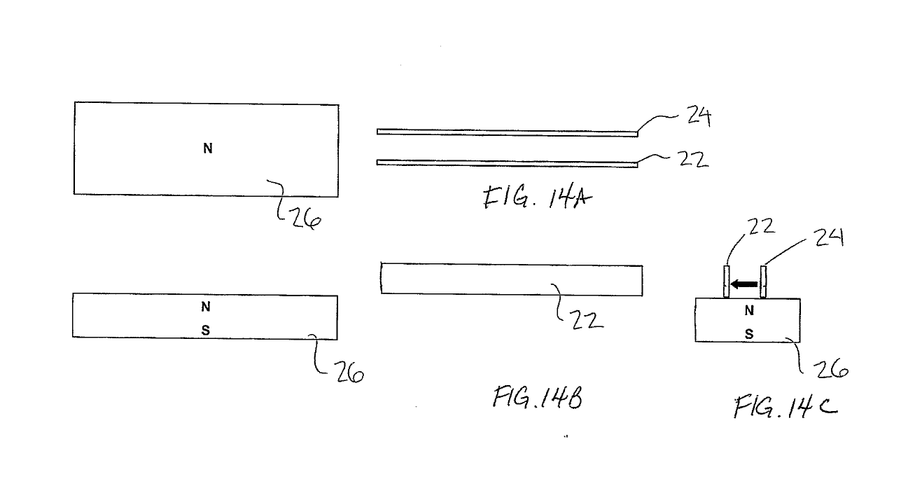

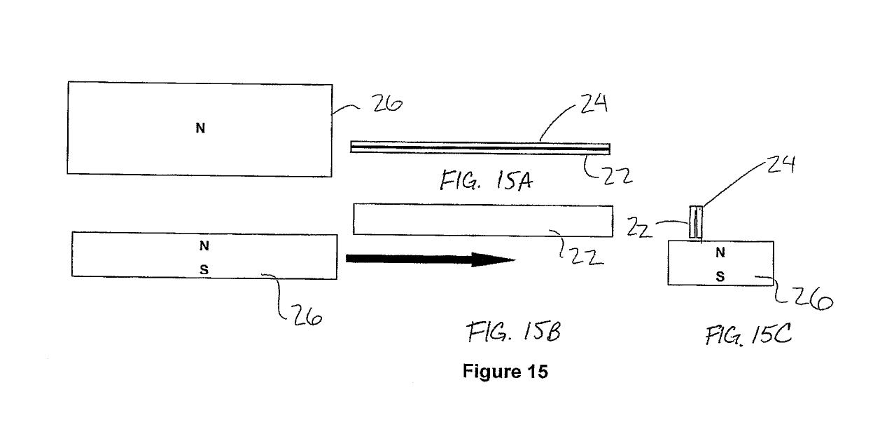

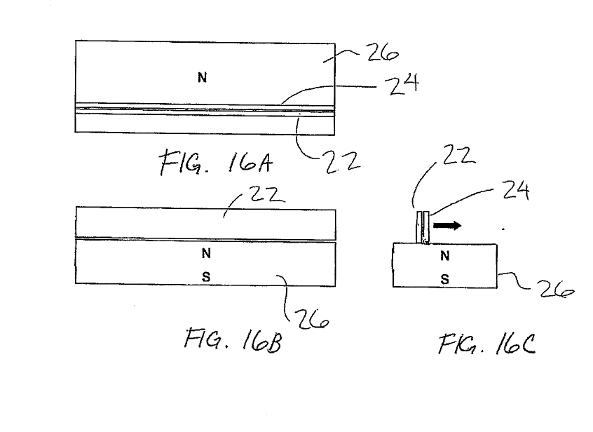

Turning now to the common features of the third embodiment of FIGS. 9 through 12, and the fourth embodiment of FIGS. 13 through 16, a magnet apparatus 10 is again described and illustrated herein. In this instance the ferromagnetic base element 22 comprises a first ferromagnetic member which is fixed in location. The movable ferromagnetic member 24 comprises a second ferromagnetic member supported for movement in the working direction between a first position adjacent the first ferromagnetic member and a second position spaced apart from the first ferromagnetic member.

The auxiliary permanent magnet 26 in this instance comprises a driving magnet which is a permanent magnet as in the previous embodiment having a magnetic flux oriented in a flux direction from a first pole at a first end face 28 of the magnet to a second pole at a second end face 30 of the magnet. The driving magnet 26 is again movable relative to the first ferromagnetic member between an engaged position in which the driving magnet is supported in proximity to the first and second ferromagnetic members and the flux direction is oriented substantially perpendicularly to the working direction of the second ferromagnetic member and a disengaged position in which the driving magnet is positioned farther from the first and second ferromagnetic members than in the engaged position.

As illustrated, the first and second ferromagnetic members span one of the end faces of the driving magnet in the engaged position. The working direction of the first ferromagnetic member is parallel the end faces of the driving magnet and the plane of movement of the driving magnet.

As in the previous embodiment, a controller functions to displace the second ferromagnetic member and the driving magnets through the first three portions of the cycle to store potential energy which is released when the fourth portion of the cycle is permitted to be completed.

The third embodiment of FIGS. 9 through 12 differs from the fourth embodiment in that there is also provided a first fixed permanent magnet 14 which has a flux direction oriented parallel and in alignment with the flux direction of the driving magnet in the engaged position. The first permanent magnet 14 is fixed relative to the first ferromagnetic member and is spaced from the driving magnet in the flux direction so that the first permanent magnet and the driving magnet are situated on opposing sides of first ferromagnetic member.

With further reference to the embodiment of FIGS. 9 through 12, the device is generally comprised of two assemblies, the plate carrier, the flux driver and a moveable output plate.

The plate carrier assembly is composed of one permanent magnet. Located perpendicular to the plate carrier magnet is a stationary ferromagnetic plate. This fixed plate is oriented perpendicular to the carrier magnet, is located in from the edge of the carrier magnet, is perpendicular to the pole face of the carrier magnet, does not touch the carrier magnet or the driver magnet and conducts magnetic flux from the carrier magnet to the driver magnet.

The output plate is oriented adjacent and parallel to the fixed plate and conducts flux between the carrier and driver magnets. The output plate is allowed to move away from the fixed plate further into the magnetic flux between the carrier and flux driver magnet pole faces and is not allowed to contact either of the carrier magnet pole faces.

The flux driver magnet is a permanent magnet with a flux density that is considerably larger than the flux density of the carrier magnet. The flux driver magnet is attracted by the carrier magnet, is parallel the carrier magnet and is at a fixed distance from the carrier magnet. The flux driver magnet is allowed to move in a plane parallel to the pole face of item 14, does not touch the stationary plate or the moveable plate.

Operation of the device comprises four cycles is as follows:

In cycle 1 (FIG. 9) the driver magnet is removed from the attractive forces generated by the carrier magnet.

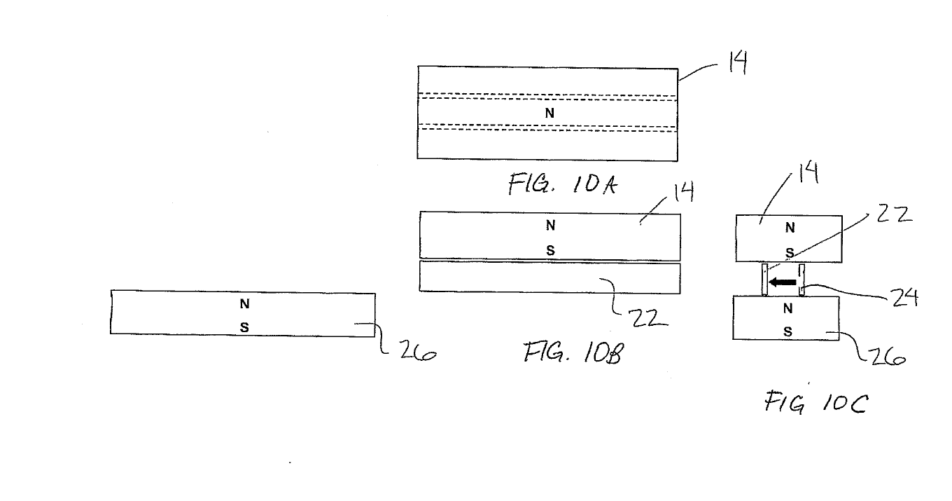

In cycle 2 (FIG. 10) the output plate is forced back adjacent to the fixed plate item 22.

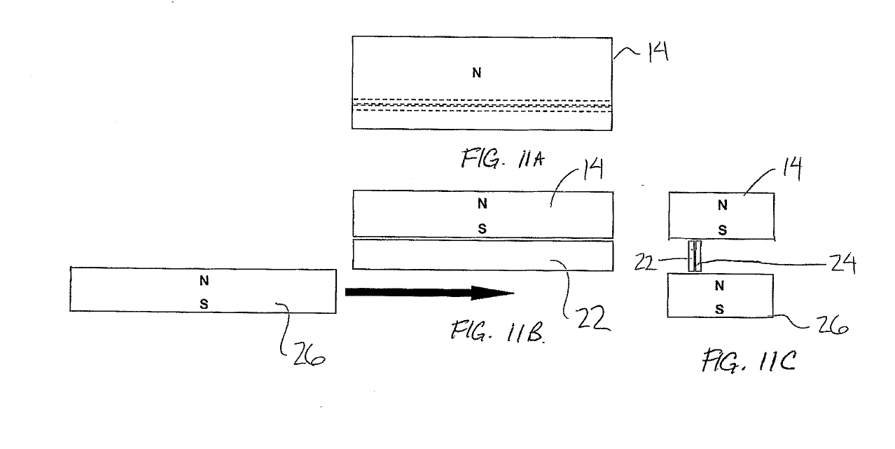

In cycle 3 (FIG. 11) the flux driver magnet is attracted by both the pole face of the carrier magnet and by the fixed and stationary plates conducting a portion of the flux between the flux driver magnet and the carrier magnet.

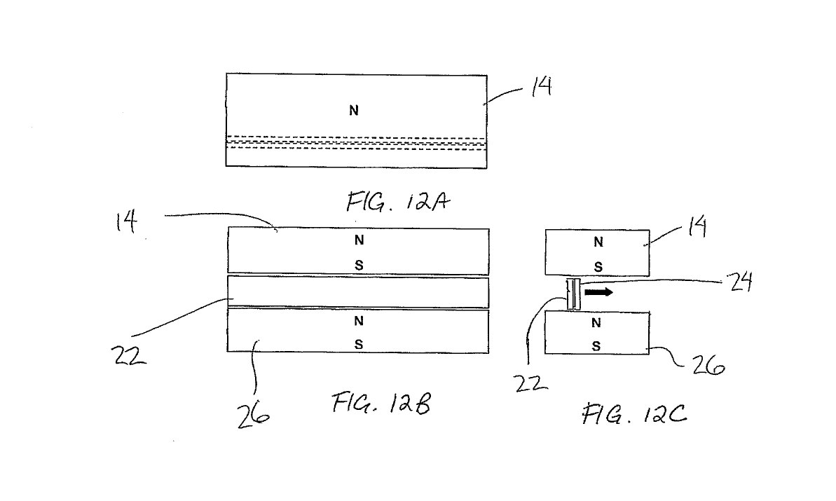

In cycle 4 (FIG. 12) the output plate and fixed plate repulse each other, thus converting potential energy into work.

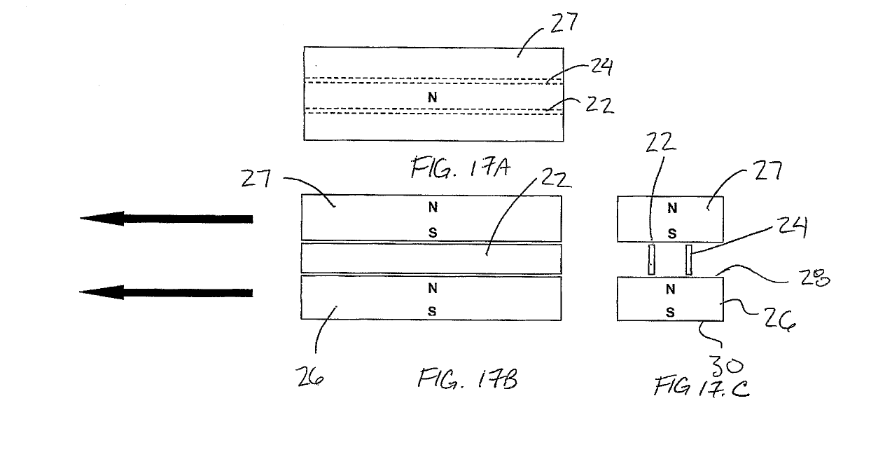

Turning now to FIGS. 17 through 20, a magnet apparatus 10 is again described and illustrated herein. Similarly to the embodiment of FIGS. 13 to 16, in this instance the ferromagnetic base element 22 comprises a first ferromagnetic member which is fixed in location and the movable ferromagnetic member 24 comprises a second ferromagnetic member supported for movement in the working direction between a first position adjacent the first ferromagnetic member and a second position spaced apart from the first ferromagnetic member.

The auxiliary permanent magnet 26 in this instance comprises a driving magnet or first movable magnet which is a permanent magnet as in the previous embodiment having a magnetic flux oriented in a flux direction from a first pole at a first end face 28 of the magnet to a second pole at a second end face 30 of the magnet.

This embodiment differs from the previous embodiment in that there is provided an additional driving magnet or second movable magnet 27 which also has a magnetic flux oriented in a flux direction from a first pole at a first end face 28 of the magnet to a second pole at a second end face 30 of the magnet.

The first movable magnet 26 and the second movable magnet 27 are both movable together to reciprocate under control of the controller. Both magnets 26 and 27 are movable relative to the first ferromagnetic member between an engaged position in which the magnets are supported in proximity to the first and second ferromagnetic members on opposing sides of the ferromagnetic members and the flux directions are oriented in a common direction in alignment with one another substantially perpendicularly to the working direction of the second ferromagnetic member and a disengaged position in which the first and second movable magnets are positioned farther from the first and second ferromagnetic members than in the engaged position. The first and second permanent magnets are movable between the engaged and disengaged positions thereof in a common direction oriented perpendicularly to the flux directions thereof.

In the engaged position, the first and second movable magnets are supported spaced apart from one another in the common flux direction thereof on opposing sides of the ferromagnetic members received therebetween. More particularly, the first and second ferromagnetic members comprise flat plate members as in the previous embodiments, which lie parallel to one another in respective planes oriented perpendicularly to the working direction such that the plates are parallel to the flux directions of the movable magnets and such that each of the plate members spans between opposing side edges thereof which are in close proximity adjacent to the first and second permanent magnets respectively. The first and second ferromagnetic members are elongate in a direction of movement of the driving magnet.

Subsequent to the engaged position, the first and second movable magnets 26 and 27 are movable together generally perpendicularly to the working direction of the second ferromagnetic member towards the disengaged position such that in the disengaged position, the first and second movable magnets are spaced from the first and second ferromagnetic members. The flux directions of the first and second movable magnets remain aligned with one another, perpendicular to the direction of movement of the magnets as the magnets are displaced to the disengaged position. The magnets in the disengaged position are situated laterally outwardly in the direction of movement thereof beyond the ends of the first and second ferromagnetic members.

In the embodiment of FIGS. 17-20, the plate assembly is composed of a stationary ferromagnetic plate and a moveable ferromagnetic output plate as described above. The stationary plate is oriented perpendicular to the carrier magnet; is located in from the edge of the carrier magnet; is perpendicular to the pole face of the carrier magnet; does not touch the carrier magnet or the driver magnet; and conducts magnetic flux from the carrier magnet to the driver magnet.

The output plate is oriented adjacent and parallel to the fixed plate. The fixed plate and the output plate both conduct flux between the carrier magnet and driver magnet. The output plate is allowed to move away from the fixed plate further into the magnetic flux between the carrier and flux driver magnet pole faces and is not allowed to contact the carrier magnet pole face or the output magnet pole face.

The flux driver magnet and carrier magnet assembly is made up of the flux driver magnet and the carrier magnet. The flux driver magnet is a permanent magnet with a flux density that is equal to or considerably larger than the flux density of the carrier magnet. The flux driver magnet is attracted by the other magnet, is parallel to the carrier magnet and is at a fixed distance from the carrier magnet. The flux driver magnet and the carrier magnet are allowed to move in a plane parallel to the pole faces of each other, are parallel to the plates and do not touch the stationary plate or the moveable plate.

The operation of the device according to FIGS. 17 to 20 comprises the following operations.

Cycle 1—In cycle 1 (FIG. 17) the driver magnet and carrier magnet are removed from the output and stationary plates.

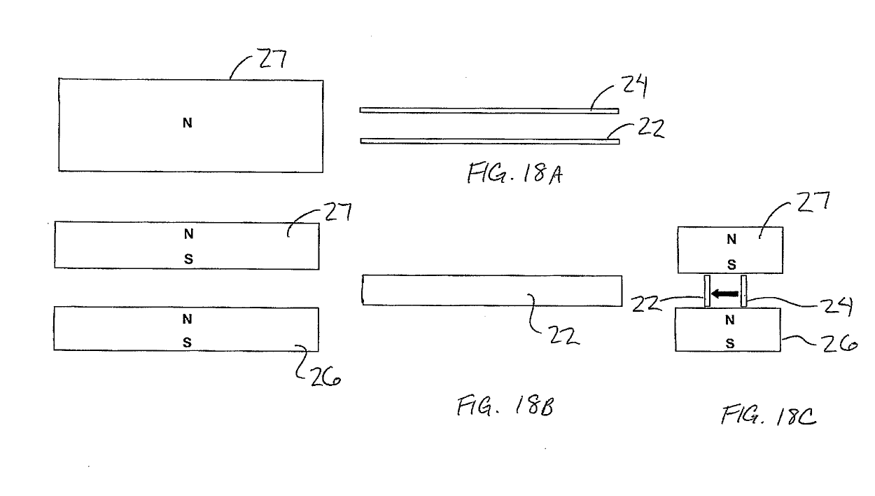

Cycle 2—In cycle 2 (FIG. 18) the output plate is forced back adjacent to the fixed plate item 22.

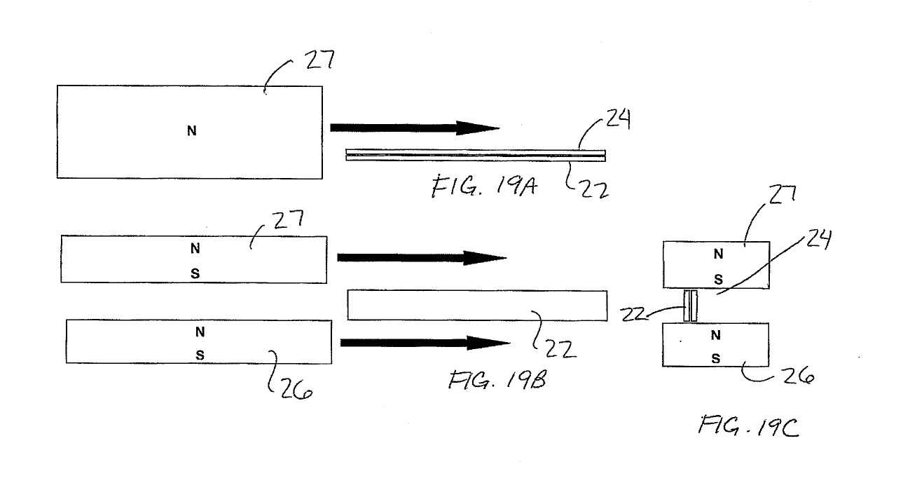

Cycle 3—In cycle 3 (FIG. 19) the flux driver magnet and carrier magnet are attracted by both the output and stationary plates.

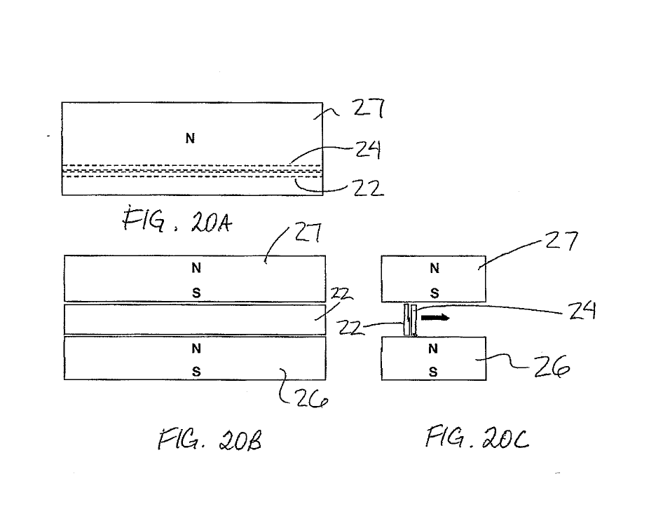

Cycle 4—In cycle 4 (FIG. 20) the output plate and fixed plate repulse each other, thus permitting stored potential energy to be released as work.

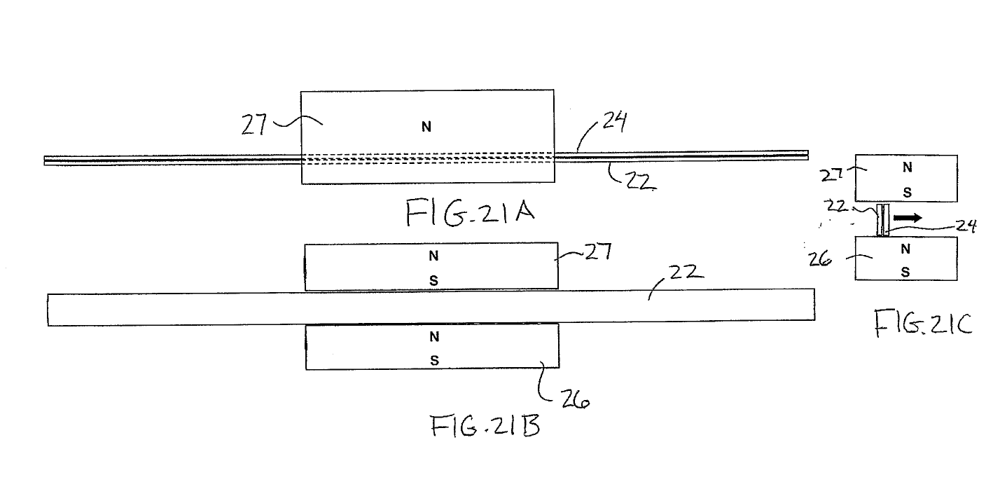

Turning now to FIG. 21, a further embodiment of the magnet apparatus 10 is illustrated in the fourth cycle thereof which is substantially identical and operates identically to the embodiment of FIGS. 17 through 20 with the exception of the fixed ferromagnetic member 22 and the movable ferromagnetic member 24 which are arranged to extend longitudinally beyond the ends of the adjacent magnets in the elongate direction of the plates and the permanent magnets instead of the ends of the ferromagnetic members being even with the ends of the permanent magnets as in the previous embodiments.

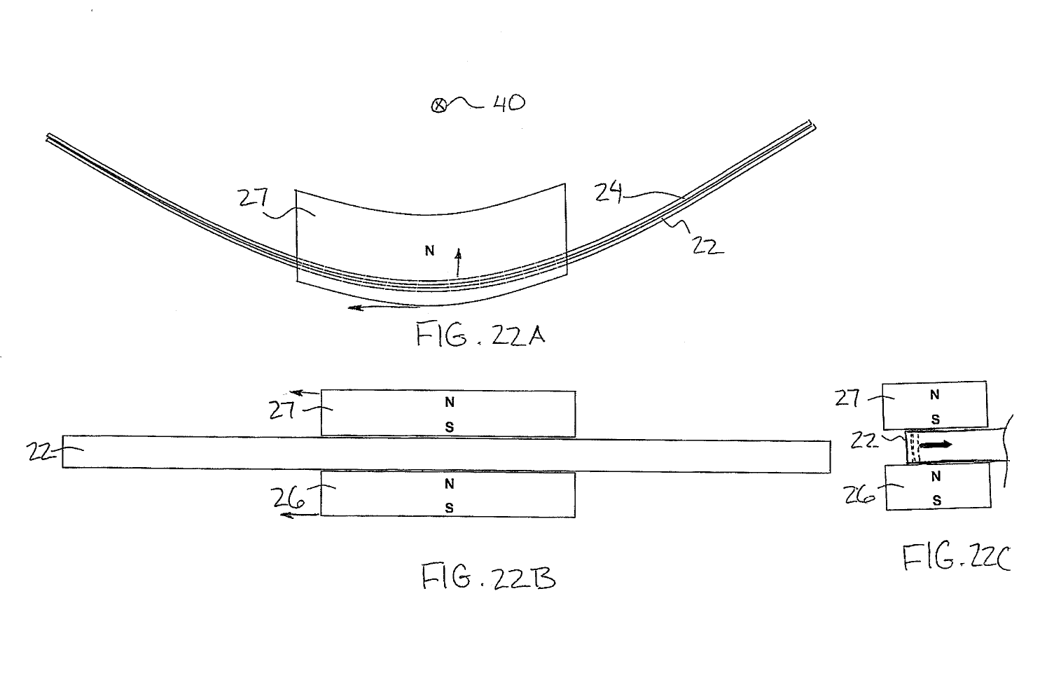

A further embodiment of the magnet apparatus 10 is shown in the fourth cycle thereof in FIG. 22. In this instance the magnet apparatus 10 is substantially identical to the embodiment of FIG. 21 with the exception of the fixed ferromagnetic member 22 and the movable ferromagnetic member 24 being substantially curved about a central axis 40. The movable ferromagnetic member is shown to be movable relative to the fixed ferromagnetic member 22 in the working direction which is oriented radially in relation to the central axis. The driving magnets 26 and 27 are thus movable in a tangential direction in relation to the central axis so that the driving magnets can be cyclically rotated about the central axis between the engaged positions and the disengaged positions of the driving magnets.

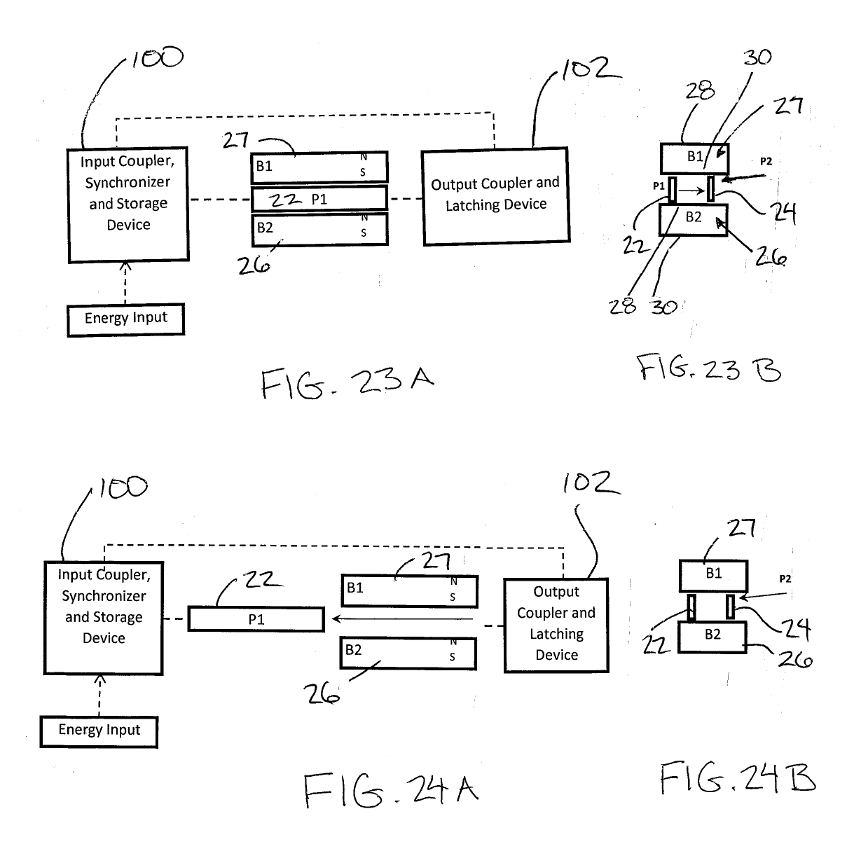

Turning now to FIGS. 23 through 26, the preferred embodiment of FIGS. 17 through 20 is again represented, but with the addition of the controller 100 and a latching mechanism 102 also being represented. The controller 100 is operatively associated with the ferromagnetic members and the driving magnet so as to be arranged in response to an input to drive the following sequence of movements corresponding to portions 1 through 3 of the cycle of operation described above. The movements include: i) displacement of the driving magnet relative to the second ferromagnetic member in the second position from the engaged position to the disengaged position, ii) displacement of the second ferromagnetic member relative to the first ferromagnetic member from the second position to the first position in the disengaged position of the driving magnet, and iii) displacement of the driving magnet relative to the second ferromagnetic member in the first position from the disengaged position to the engaged position.

Once in the starting position of the fourth portion of the cycle of operation, the second ferromagnetic member is biased from the first position to the second position relative to the first ferromagnetic member due to the driving magnet being in the engaged position relative to the ferromagnetic members. Retaining the second ferromagnetic member in the second position permits energy to be stored by the apparatus as potential energy. Releasing the second ferromagnetic member to return to the first position releases the potential energy so as to be arranged to selectively drive an output movement in response to the initial inputs provided by the controller as described above.

The driving of the movements through the first three portions of the cycle can be accomplished by the controller using various configurations of conventional actuators which are mechanically, electrically, pneumatically, or hydraulically actuated for example.

The latching mechanism 102 is arranged to latch the second ferromagnetic member in the first position relative to the first ferromagnetic member when the driving magnet is in the disengaged position relative to the ferromagnetic members. When latched, the latching mechanism retains the first and second ferromagnetic members coupled in the first position. The latching mechanism may include any suitable type of actuator to enable the latching function to be released on demand. The releasing of the latch mechanism can also be accomplished using various configurations of conventional actuators which are mechanically, electrically, pneumatically, or hydraulically actuated for example. Accordingly the latching mechanism is selectively releasable by the controller so as drive the output movement on demand.

The sequence of movements throughout the cycle and the involvement of the controller 100 and latching mechanism 102 will now be described in further detail with reference to FIGS. 23 to 26.

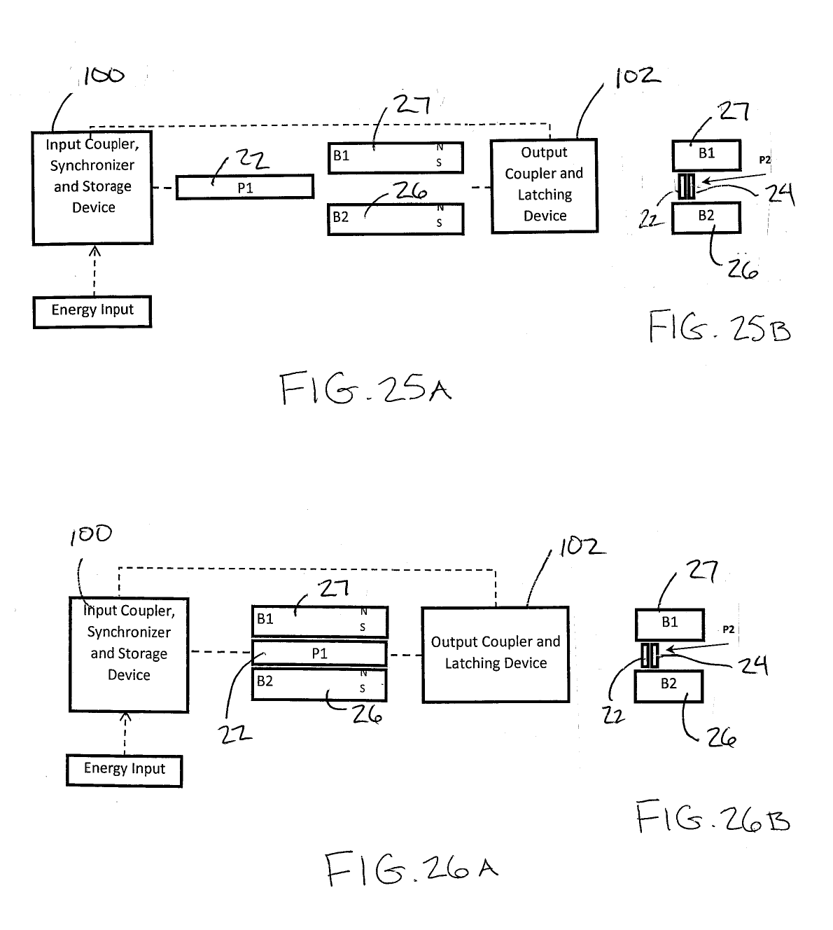

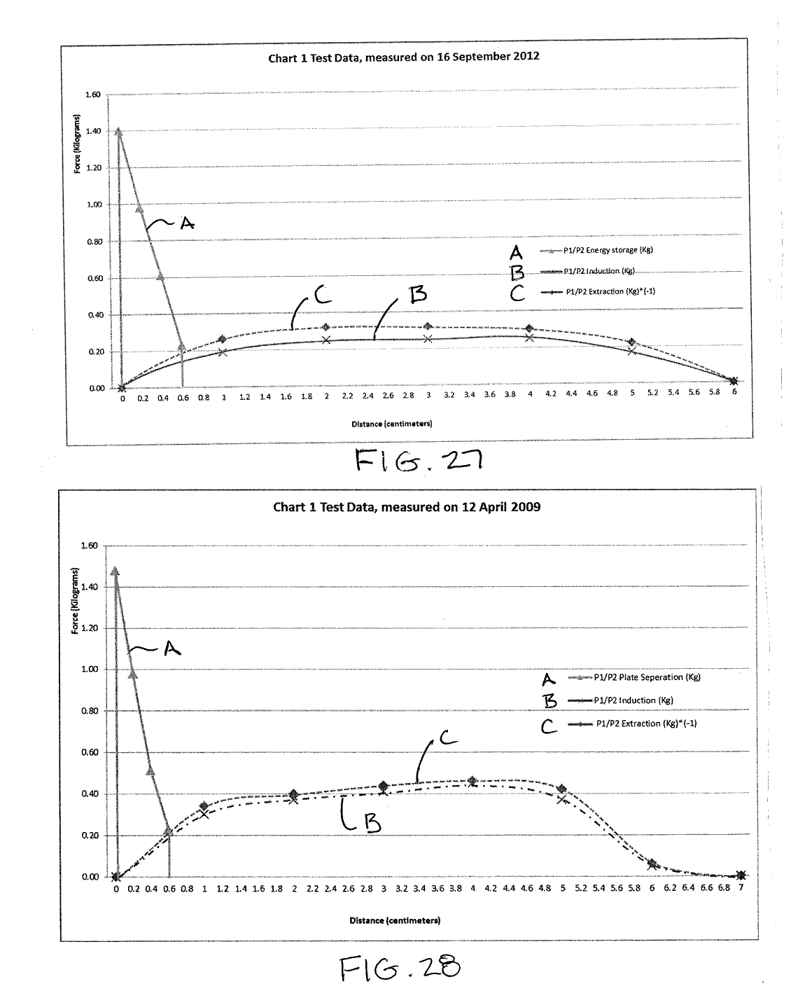

After the energy release movement from the position of FIG. 26 to the position of FIG. 23, the controller functions of an input coupler, synchronizer and storage device will couple the input energy to P1 and also couple to P1 the energy it has stored during the movement from FIG. 25 to FIG. 26 (described in further detail below) that is from the induction of P1 and P2 (P1/P2 Induction (KG)) as shown in the graphs on FIGS. 27 and 28. The ferromagnetic members are displaced relative to the driving magnets by the controller 100 using the input energy from the position of FIG. 23 to the position of FIG. 24.

In the position of FIG. 24, the controller 100 provides further input to drive the members 22 and 24 (P1 and P2) together. When P1 and P2 are removed form the influence of magnetic fields of B1 and B2 they will demagnetize and therefore the energy required to displace P2 relative to P1 at this stage of the cycle is not significant and was not large enough to measure and does not show on Graphs of FIGS. 27 and 28.

With P1 & P2 close together and located on the edge of the B1 and B2 magnetic field. as shown in FIG. 25, the latching mechanism 102 is used to retain the members 22 and 24 (P1 and P2) coupled together as they are displaced from the position of FIG. 25 to the position of FIG. 26. The energy by the build up of repulsive force between P1 and P2 is stored as potential energy by the latching mechanism 102 because these plates are held together during induction. This energy is shown in the graphs of FIGS. 27 and 28 1 as the area data plot P1/P2 Energy storage (Kg*cm). The synchronizer and storage device can also store 90% of the mechanical work generated by the induction of P1 and P2 between B1 and B2. This stored mechanical work can be used in a later movement of the next cycle as noted above. This mechanical energy is show in graph 1 as data plot P1/P2 Induction (Kg). Not all of this mechanical energy can be stored in the synchronizer storage device otherwise P1 and P2 will not be moved (that is be inducted between B1 and B2).

Once in the position of FIG. 26, on demand the synchronizer will unlatch the output coupler of the latching mechanism 102 such that P2 is allowed to move and thereby release the energy stored between P1 and P2. This is represented as the data plot P1/P2 Induction (Kg) as shown in the Graphs of FIGS. 27 and 28.

In yet further embodiments, the first ferromagnetic member may not be required such that the second ferromagnetic member 24/P2 may be the only ferromagnetic member of the apparatus. In this instance, the second ferromagnetic member 24 is balanced within the magnetic flux of the driving magnets in the first position such that displacement in the working direction to the second position thereof similarly causes the magnetic flux to bias the second ferromagnetic member to return to the first position. Accordingly the same cycle of movements as described in FIGS. 23 to 26 can be achieved even when the first ferromagnetic member 22 is removed.

Examples of uses of the apparatus 10 include: i) storage of energy from solar power in which the apparatus will store the power from solar energy captured during the day and released at night when there is no solar power; ii) provide additional torque on demand to assist a motor handle a spike load; or iii) provide power to mechanically open or close remote large valves where power is generated at a low rate by a solar cell in which the device would store energy slowly at a low rate and release a high level of power over a short period.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A magnet apparatus comprising:
a first ferromagnetic member;
a second ferromagnetic member supported for movement in a working direction relative to the first ferromagnetic member between a first position adjacent the first ferromagnetic member and a second position spaced apart from the first ferromagnetic member;
a driving magnet comprising a permanent magnet having a magnetic flux oriented in a flux direction from a first pole at a first end face of the magnet to a second pole at a second end face of the magnet;
the driving magnet being movable relative to the first ferromagnetic member between an engaged position in which the driving magnet is supported in proximity to the first and second ferromagnetic members and the flux direction is oriented substantially perpendicularly to the working direction of the second ferromagnetic member and a disengaged position in which the driving magnet is positioned farther from the first and second ferromagnetic members than in the engaged position; and
a controller operatively associated with the ferromagnetic members and the driving magnet so as to be arranged in response to an input to drive a sequence of movements including:
i) displacement of the driving magnet relative to the second ferromagnetic member in the second position from the engaged position to the disengaged position;
ii) displacement of the second ferromagnetic member relative to the first ferromagnetic member from the second position to the first position in the disengaged position of the driving magnet;
iii) displacement of the driving magnet relative to the second ferromagnetic member in the first position from the disengaged position to the engaged position;
whereby the second ferromagnetic member is biased from the first position to the second position relative to the first ferromagnetic member when the driving magnet is in the engaged position relative to the ferromagnetic members so as to be arranged to selectively drive an output movement in response to the input to the controller.

2. The magnet apparatus according to claim 1 wherein the controller further comprises a latching mechanism arranged to latch the second ferromagnetic member in the first position relative to the first ferromagnetic member when the driving magnet is in the disengaged position relative to the ferromagnetic members, the latching mechanism being selectively releasable so as drive the output movement when the latching mechanism is released on demand.

3. The magnet apparatus according to claim 1 wherein the driving magnet comprises a first movable magnet and wherein there is provided an additional driving magnet comprising a second movable magnet;
the second movable magnet comprising a permanent magnet having a magnetic flux oriented in a flux direction from a first pole at a first end face of the magnet to a second pole at a second end face of the magnet; and
the second movable magnet being movable relative to the first ferromagnetic member between an engaged position in which the second movable magnet is supported in proximity to the first and second ferromagnetic members and the flux direction is oriented substantially perpendicularly to the working direction of the second ferromagnetic member in alignment with the flux direction of the first movable magnet and a disengaged position in which the driving magnet is positioned farther from the first and second ferromagnetic members than in the engaged position thereof.

4. The magnet apparatus according to claim 3 wherein the first and second movable magnets are movable together between the engaged and disengaged positions thereof.

5. The magnet apparatus according to claim 3 wherein the first and second movable magnets are movable between the engaged and disengaged positions thereof in a common direction oriented perpendicularly to the flux directions thereof.

6. The magnet apparatus according to claim 3 wherein the first and second movable magnets are supported spaced apart from one another in the flux direction in the engaged position of the magnets on opposing sides of the ferromagnetic members received therebetween.

7. The magnet apparatus according to claim 3 wherein the first and second ferromagnetic members comprise flat plate members lying parallel to one another in respective planes oriented parallel to the flux directions of the movable magnets, each of the plate members spanning between opposing side edges in proximity to the first and second permanent magnets in the engaged position respectively.

8. The magnet apparatus according to claim 1 wherein the first and second ferromagnetic members comprise flat plate members lying parallel to one another and being substantially perpendicular to the working direction.

9. The magnet apparatus according to claim 1 wherein the first and second ferromagnetic members comprise flat plate members which are elongate in a direction of movement of the driving magnet.

10. The magnet apparatus according to claim 1 wherein there is provided a first fixed magnet comprising a permanent magnet supported in fixed relation to the first ferromagnetic member and having a magnetic flux oriented parallel and in alignment with the flux direction of the driving magnet in the engaged position.

11. The magnet apparatus according to claim 10 wherein the first fixed magnet and the driving magnet are spaced apart in the flux direction on opposing sides of first ferromagnetic member.

12. The magnet apparatus according to claim 1 wherein the first and second ferromagnetic members span one of the end faces of the driving magnet in the engaged position.

13. The magnet apparatus according to claim 1 wherein there is provided a first fixed magnet and a second fixed magnet, each fixed magnet comprising a permanent magnet supported in fixed relation to the first ferromagnetic member and having a magnetic flux oriented parallel and in alignment with the flux direction of the driving magnet in the engaged position, the first and second fixed magnets being supported spaced apart in the flux direction on opposing sides of the first ferromagnetic member.

14. The magnet apparatus according to claim 13 wherein the second fixed magnet is received between first ferromagnetic member and the driving magnet in the engaged position of the driving magnet.

15. The magnet apparatus according to claim 1 wherein the working direction is parallel to the end face of driving magnet which is nearest to the first ferromagnetic member.

16. The magnet apparatus according to claim 1 wherein the driving magnet is movable between the engaged and disengaged positions thereof in a plane which substantially parallel to working direction.

17. The magnet apparatus according to claim 1 wherein the driving magnet is movable between the engaged and disengaged positions thereof perpendicularly to the flux direction and perpendicularly to the working direction of the first and second ferromagnetic members.

18. The magnet apparatus according to claim 1 wherein the controller is arranged to linearly reciprocate the driving magnet between the engaged position and the disengaged position thereof.

19. The magnet apparatus according to claim 1 wherein the first and second ferromagnetic members are curved about a central axis, the working direction is oriented radially in relation to the central axis, and the driving magnet is movable in a tangential direction in relation to the central axis.

20. A magnet apparatus comprising:
a ferromagnetic member supported for movement in a working direction a first position and a second position spaced apart from the first position;
a driving magnet comprising a permanent magnet having a magnetic flux oriented in a flux direction from a first pole at a first end face of the magnet to a second pole at a second end face of the magnet;
the driving magnet being movable relative to the ferromagnetic member between an engaged position in which the driving magnet is supported in proximity to the ferromagnetic member and the flux direction is oriented substantially perpendicularly to the working direction of the ferromagnetic member and a disengaged position in which the driving magnet is positioned farther from the ferromagnetic member than in the engaged position; and
a controller operatively associated with the ferromagnetic member and the driving magnet so as to be arranged in response to an input to drive a sequence of movements including:
i) displacement of the driving magnet relative to the ferromagnetic member in the second position from the engaged position to the disengaged position;
ii) displacement of the ferromagnetic member relative to the driving magnet from the second position to the first position in the disengaged position of the driving magnet;
iii) displacement of the driving magnet relative to the ferromagnetic member in the first position from the disengaged position to the engaged position;
whereby the ferromagnetic member is biased by the driving magnet from the first position to the second position when the driving magnet is in the engaged position relative to the ferromagnetic member so as to be arranged to selectively drive an output movement in response to the input to the controller.
